(19) United States
(12) Patent Application Publication
(10) Pub. No.: US 2025/0081231 A1
(43) Pub. Date: Mar. 6, 2025

(54) RSSI MEASUREMENT FOR CBR CALCULATION

(71) Applicant: QUALCOMM Incorporated, San Diego, CA (US)

(72) Inventors: Hui GUO, Beijing (CN); Tien Viet NGUYEN, Bridgewater, NJ (US); Kapil GULATI, Belle Mead, NJ (US); Chu-Hsiang HUANG, San Diego, CA (US); Gabi SARKIS, San Diego, CA (US); Sourjya DUTTA, San Diego, CA (US); Shuanshuan WU, San Diego, CA (US)

(21) Appl. No.: 18/290,753

(22) PCT Filed: Sep. 24, 2021
(86) PCT No.: PCT/CN2021/120112

§ 371 Date: Jan. 19, 2024

(51) Int. Cl. H04W 74/0808; H04L 5/16; H04W 92/18

(52) U.S. Cl. CPC H04W 74/0808; H04L 5/16; H04W 92/18

(57) ABSTRACT

A wireless device that supports sidelink communication may transmit a sidelink transmission in a first set of one or more slots. The wireless device may measure a received signal strength indicator (RSSI) in a second set of slots, the RSSI indicative of a channel busy ratio (CBR) over a combined set of slots including both the first set of one or more slots and the second set of slots and transmit the sidelink communication based on the CBR associated with the combined set of slots.

### TECHNICAL FIELD

The present disclosure relates generally to communication systems, and more particularly, to channel busy ratio (CBR) calculation techniques.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communication (URLLC). Some aspects of 5G NR may be based on the 4G Long Term Evolution (LTE) standard. Some aspects of wireless communication may comprise direct communication between devices based on sidelink. There exists a need for further improvements in sidelink technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, an apparatus for wireless communication at a wireless device that supports sidelink communication is provided. The apparatus includes a memory and at least one processor coupled to the memory, the memory and the at least one processor are configured to transmit a sidelink transmission in a first set of one or more slots. The apparatus is configured to measure a received signal strength indicator (RSSI) in a second set of slots, the RSSI indicative of a channel busy ratio (CBR) over a combined set of slots including both the first set of one or more slots and the second set of slots; and transmit the sidelink communication based on the CBR associated with the combined set of slots.

In another aspect of the disclosure, a method of wireless communication at a wireless device that supports sidelink communication is provided. The method includes transmitting a sidelink transmission in a first set of one or more slots. The method includes measuring a RSSI in a second set of slots, the RSSI indicative of a CBR over a combined set of slots including both the first set of one or more slots and the second set of slots; and transmitting the sidelink communication based on the CBR associated with the combined set of slots.

In another aspect of the disclosure, an apparatus for wireless communication at a wireless device that supports sidelink communication is provided. The apparatus includes means for transmitting a sidelink transmission in a first set of one or more slots, means for measuring an RSSI in a second set of slots, the RSSI indicative of a CBR over a combined set of slots including both the first set of one or more slots and the second set of slots; and means for transmitting the sidelink communication based on the CBR associated with the combined set of slots.

In another aspect of the disclosure, a non-transitory computer-readable storage medium at a wireless device that supports sidelink communication, is provided. The non-transitory computer-readable storage medium is configured to transmit a sidelink transmission in a first set of one or more slots; measure an RSSI in a second set of slots, the RSSI indicative of a CBR over a combined set of slots including both the first set of one or more slots and the second set of slots; and transmit the sidelink communication based on the CBR associated with the combined set of slots.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network, in accordance with aspects presented herein.

FIG. 2 illustrates example aspects of a sidelink slot structure, in accordance with aspects presented herein.

FIG. 3 is a diagram illustrating an example of a base station and user equipment (UE) in an access network, in accordance with aspects presented herein.

FIG. 4 illustrates examples of resource reservation for sidelink communication, in accordance with aspects presented herein.

FIG. 5 is a communication flow diagram illustrating communications between wireless devices that support sidelink communication, in accordance with aspects presented herein.

FIG. 6 illustrates a slot diagram having a total number of slots that include both transmit slots and receive slots, in accordance with aspects presented herein.

FIG. 7 is a flowchart of a method of wireless communication at a wireless device that supports sidelink communication, in accordance with aspects presented herein.

FIG. 8 is a flowchart of a method of wireless communication at a wireless device that supports sidelink communication, in accordance with aspects presented herein.

FIG. 9 is a diagram illustrating an example of a hardware implementation for an example apparatus, in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more examples, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Aspects described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described aspects may occur. Implementations may range a spectrum from chip-level or modular components to non-modular, non-chip-level implementations and further to aggregate, distributed, or original equipment manufacturer (OEM) devices or systems incorporating one or more aspects of the described aspects. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that aspects described herein may be practiced in a wide variety of devices, chip-level components, systems, distributed arrangements, aggregated or disaggregated components (e.g., associated with a user equipment (UE) and/or a base station), end-user devices, etc. of varying sizes, shapes, and constitution.

A channel busy ratio (CBR) may be calculated by a wireless device to determine whether to activate or deactivate a congestion control behavior of the wireless device. The CBR may be defined as a ratio between a time the channel is sensed by the wireless device as busy and a total observation time window of the wireless device. A high CBR may correspond to a congested communication environment. In order to determine the CBR, the wireless device may perform a received signal strength indicator (RSSI) measurement over a given time window. Each slot that exceeds an RSSI threshold may be counted toward the CBR calculation as being busy. In some aspects, a wireless device may operate in a half-duplex mode in which the device transmits and receives at non-overlapping times.

While the RSSI is measured over the given time window, half-duplex operation may cause the wireless device to be unable to measure a received signal strength while the wireless device is performing a transmission. As an example, a CBR measurement may be based on a number of slots. As one non-limiting example, the CBR may be based on a consecutive 200 slots for a 30 kHz subcarrier spacing. If there are 10 sub-channels per slot, the potential total number of RSSI measurements in 2000. An RSSI threshold may be −88 dBm. If the RSSI for a sub-channel in a slot is larger than the threshold (e.g., −88 dBm), the sub-channel is considered busy. Otherwise, the sub-channel is considered not busy. If 200 sub-channels over the measurement duration of slots are considered busy based on the RSSI measurement, then the CBR=200 busy sub-channels/2000 potential sub-channels. However, if the device operates in a half-duplex mode and transmits sidelink packets in 6 of the 200 slots, then the device does not measure the RSSI in the 6 slots (e.g., corresponding to 60 sub-channels).

Aspects presented herein enable the RSSI measurement procedures for CBR calculations to account for the slots/sub-channels that the wireless device is unable to, or does not, measure an RSSI based on the half-duplex transmission. For example, a, such as a roadside unit (RSU), may have a 20 percent duty cycle (e.g., a cycle of transmission and reception by the RSU in which transmissions occupy 20 percent of the cycle's time resources) that generates a 20 percent uncertainty in the CBR calculation, since the wireless device is only able to measure the RSSI during 80 percent of the time window, which may cause a reporting bias. Aspects presented herein provide a unified set of CBR calculation protocols that take into account half-duplex operation of a device in order to provide more consistent CBR measurements between devices regardless of half-duplex or full-duplex operation. In some aspects, the CBR calculation protocol may account for the set of transmit slots included in a CBR measurement time window when the wireless device is unable to measure the RSSI, e.g., due to transmitting in a half-duplex operation.

A first CBR calculation technique may involve excluding the transmit slots from the count of busy slots, and normalizing the number of slots for the CBR calculation based on the receive slots where the wireless device is able to measure the RSSI (e.g., normalizing the number of slots of the CBR calculation to exclude the transmit slots). A second CBR calculation technique may include not counting the transmit slots as busy and including each slot in the number of slots for the CBR calculation by basing the CBR calculation on both the transmit slots and the receive slots. A third CBR calculation technique may include counting the transmit sub-channels of the transmit slots as busy and including each slot in the count of the number of slots. A fourth CBR calculation technique may include counting the transmit sub-channels of the transmit slots as busy, counting non-transmit sub-channels of the in the same transmit slots as not busy, and not normalizing the number of slots. By providing a set of CBR calculation protocols that take into account half-duplex operation of a device, the CBR measurements may be more consistent between devices regardless of half-duplex or full-duplex operation.

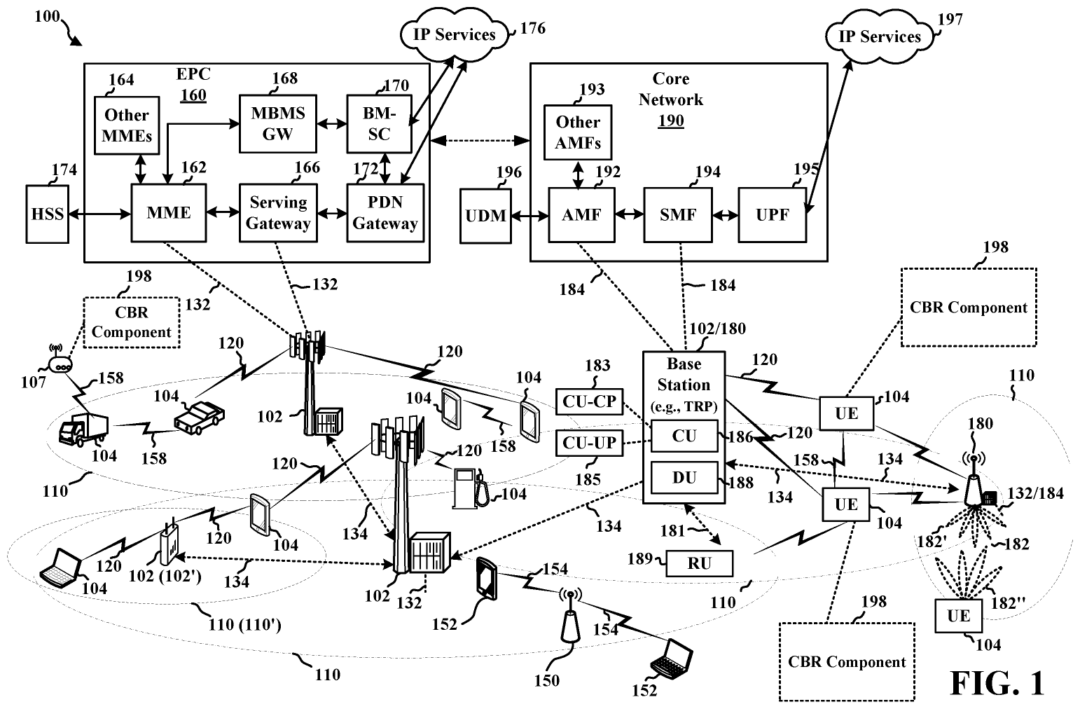

FIG. 1 is a diagram illustrating an example of a wireless communications system and an access network 100. Referring to FIG. 1, in certain aspects, a UE 104 may include a CBR component 198 configured to transmit a sidelink transmission in a first set of one or more slots; measure a received signal strength in a second set of one or more slots, the received signal strength indicative of a channel busy ratio (CBR) over a combined set of slots including both the first set of one or more slots and the second set of one or more slots; and transmit a sidelink communication based on the CBR associated with both the first set of one or more slots and the second set of one or more slots. Although the following description may be focused on 5G NR, the concepts described herein may be applicable to other similar areas, such as LTE, LTE-A, CDMA, GSM, and other wireless technologies.

The wireless communications system (also referred to as a wireless wide area network (WWAN)) in FIG. 1 is illustrated to include base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

A link between a UE 104 and a base station 102 or 180 may be established as an access link, e.g., using a Uu interface. Other communication may be exchanged between wireless devices based on sidelink. For example, some UEs 104 may communicate with each other directly using a device-to-device (D2D) communication link 158. In some examples, the D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

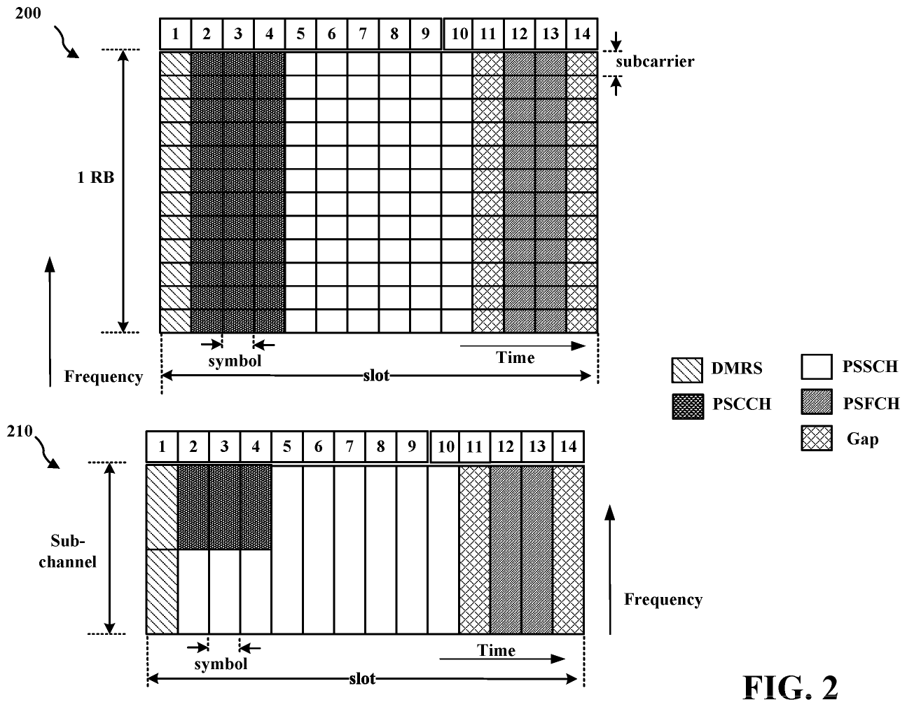

Some examples of sidelink communication may include vehicle-based communication devices that can communicate from vehicle-to-vehicle (V2V), vehicle-to-infrastructure (V2I) (e.g., from the vehicle-based communication device to road infrastructure nodes such as a Road Side Unit (RSU)), vehicle-to-network (V2N) (e.g., from the vehicle-based communication device to one or more network nodes, such as a base station), vehicle-to-pedestrian (V2P), cellular vehicle-to-everything (C-V2X), and/or a combination thereof and/or with other devices, which can be collectively referred to as vehicle-to-anything (V2X) communications. Sidelink communication may be based on V2X or other D2D communication, such as Proximity Services (ProSe), etc. In addition to UEs, sidelink communication may also be transmitted and received by other transmitting and receiving devices, such as Road Side Unit (RSU) 107, etc. Sidelink communication may be exchanged using a PC5 interface, such as described in connection with the example in FIG. 2. Although the following description, including the example slot structure of FIG. 2, may provide examples for sidelink communication in connection with 5G NR, the concepts described herein may be applicable to other similar areas, such as LTE, LTE-A, CDMA, GSM, and other wireless technologies.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

A base station 102, whether a small cell 102′ or a large cell (e.g., macro base station), may include and/or be referred to as an eNB, gNodeB (gNB), or another type of base station. Some base stations 180, such as gNB may operate in a traditional sub 6 GHz spectrum, in millimeter wave frequencies, and/or near millimeter wave frequencies in communication with the UE 104. When the gNB operates in millimeter wave or near millimeter wave frequencies, the gNB may be referred to as a millimeter wave base station. The millimeter wave base station (e.g., base station 180) may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, which may be associated with the second backhaul link 184 from the base station 102, other AMFs 193, a Session Management Function (SMF) 194, which may also be associated with the second backhaul link 184 from the base station 102, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 may include a centralized unit (CU) 186 for higher layers of a protocol stack and/or a distributed unit (DU) 188 for lower layers of the protocol stack. The CU 186 may be associated with a CU-control plane (CU-CP) 183 and a CU-user plane (CU-UP) 185. The CU-CP 183 may be a logical node that hosts a radio resource control (RRC) and a control portion of a packet data convergence protocol (PDCP). The CU-UP 185 may be a logical node that hosts a user plane portion of the PDCP. In further aspects, the base station 102 may communicate with a radio unit (RU) 189 over a fronthaul link 181. For example, the RU 189 may relay communications between the DU 188 and the UE 104. Accordingly, while some functions, operations, procedures, etc., may be described herein for exemplary purposes in association with a base station, the functions, operations, procedures, etc., may be additionally or alternatively performed by other devices, such as devices associated with open-RAN (O-RAN) deployments.

The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

FIG. 2 includes diagrams 200 and 210 illustrating example aspects of slot structures that may be used for sidelink communication (e.g., between UEs 104, RSU 107, etc.). The slot structure may be within a 5G/NR frame structure in some examples. In other examples, the slot structure may be within an LTE frame structure. Although the following description may be focused on 5G NR, the concepts described herein may be applicable to other similar areas, such as LTE, LTE-A, CDMA, GSM, and other wireless technologies. The example slot structure in FIG. 2 is merely one example, and other sidelink communication may have a different frame structure and/or different channels for sidelink communication. A frame (10 ms) may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. Diagram 200 illustrates a single resource block of a single slot transmission, e.g., which may correspond to a 0.5 ms transmission time interval (TTI). A physical sidelink control channel may be configured to occupy multiple physical resource blocks (PRBs), e.g., 10, 12, 15, 20, or 25 PRBs. The PSCCH may be limited to a single sub-channel. A PSCCH duration may be configured to be 2 symbols or 3 symbols, for example. A sub-channel may comprise 10, 15, 20, 25, 50, 75, or 100 PRBs, for example. The resources for a sidelink transmission may be selected from a resource pool including one or more sub-channels. As a non-limiting example, the resource pool may include between 1-27 sub-channels. A PSCCH size may be established for a resource pool, e.g., as between 10-100% of one sub-channel for a duration of 2 symbols or 3 symbols. The diagram 210 in FIG. 2 illustrates an example in which the PSCCH occupies about 50% of a sub-channel, as one example to illustrate the concept of PSCCH occupying a portion of a sub-channel. The physical sidelink shared channel (PSSCH) occupies at least one sub-channel. The PSCCH may include a first portion of sidelink control information (SCI), and the PSSCH may include a second portion of SCI in some examples.

A resource grid may be used to represent the frame structure. Each time slot may include a resource block (RB) (also referred to as physical RBs (PRBs)) that extends 12 consecutive subcarriers. The resource grid is divided into multiple resource elements (REs). The number of bits carried by each RE depends on the modulation scheme. As illustrated in FIG. 2, some of the REs may include control information in PSCCH and some REs may include demodulation RS (DMRS). At least one symbol may be used for feedback. FIG. 2 illustrates examples with two symbols for a physical sidelink feedback channel (PSFCH) with adjacent gap symbols. A symbol prior to and/or after the feedback may be used for turnaround between reception of data and transmission of the feedback. The gap enables a device to switch from operating as a transmitting device to prepare to operate as a receiving device, e.g., in the following slot. Data may be transmitted in the remaining REs, as illustrated. The data may comprise the data message described herein. The position of any of the data, DMRS, SCI, feedback, gap symbols, and/or LBT symbols may be different than the example illustrated in FIG. 2. Multiple slots may be aggregated together in some aspects.

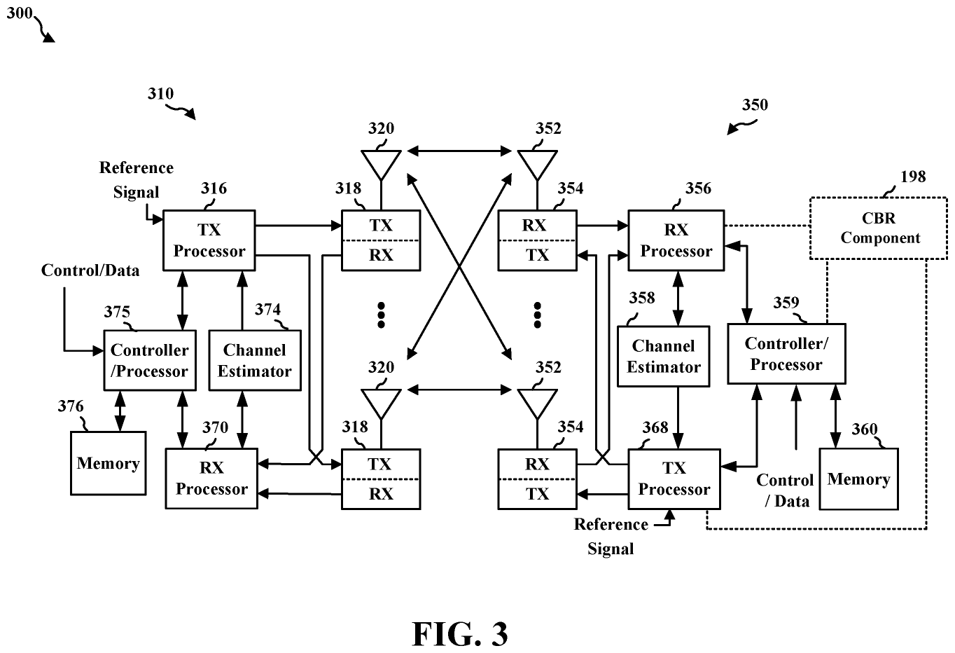

FIG. 3 is a block diagram 300 of a first wireless communication device 310 in communication with a second wireless communication device 350 based on sidelink. In some examples, the devices 310 and 350 may communicate based on V2X or other D2D communication. The communication may be based on sidelink using a PC5 interface. The devices 310 and the 350 may comprise a UE, an RSU, a base station, etc. Packets may be provided to a controller/processor 375 that implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the device 350. Each spatial stream may then be provided to a different antenna 320 via a separate transmitter 318TX. Each transmitter 318TX may modulate an RF carrier with a respective spatial stream for transmission.

At the device 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the device 350. If multiple spatial streams are destined for the device 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by device 310. These soft decisions may be based on channel estimates computed by the channel estimator 358. The soft decisions are then decoded and deinterleaved to recover the data and control signals that were originally transmitted by device 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. The controller/processor 359 may provide demultiplexing between transport and logical channels, packet reassembly, deciphering, header decompression, and control signal processing. The controller/processor 359 is also responsible for error detection using an ACK and/or NACK protocol to support HARQ operations.

Similar to the functionality described in connection with the transmission by device 310, the controller/processor 359 may provide RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by device 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The transmission is processed at the device 310 in a manner similar to that described in connection with the receiver function at the device 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. The controller/processor 375 provides demultiplexing between transport and logical channels, packet reassembly, deciphering, header decompression, control signal processing. The controller/processor 375 is also responsible for error detection using an ACK and/or NACK protocol to support HARQ operations.

At least one of the TX processor 368, the RX processor 356, and the controller/processor 359 may be configured to perform aspects in connection with the CBR component 198 of FIG. 1.

Wireless communication systems may be configured to share available system resources and provide various telecommunication services (e.g., telephony, video, data, messaging, broadcasts, etc.) based on multiple-access technologies such as CDMA systems, TDMA systems, FDMA systems, OFDMA systems, SC-FDMA systems, TD-SCDMA systems, etc. that support communication with multiple users. In many cases, common protocols that facilitate communications with wireless devices are adopted in various telecommunication standards. For example, communication methods associated with eMBB, mMTC, and ultra-reliable low latency communication (URLLC) may be incorporated in the 5G NR telecommunication standard, while other aspects may be incorporated in the 4G LTE standard. As mobile broadband technologies are part of a continuous evolution, further improvements in mobile broadband remain useful to continue the progression of such technologies.

Sidelink communication may be based on different types or modes of resource allocation mechanisms. In a first resource allocation mode (which may be referred to herein as “Mode 1”), centralized resource allocation may be provided by a network entity. For example, a base station 102 or 180 may determine resources for sidelink communication and may allocate resources to different UEs 104 to use for sidelink transmissions. In this first mode, a UE receives the allocation of sidelink resources from the base station 102 or 180. In a second resource allocation mode (which may be referred to herein as “Mode 2”), distributed resource allocation may be provided. In Mode 2, each UE may autonomously determine resources to use for sidelink transmission. In order to coordinate the selection of sidelink resources by individual UEs, each UE may use a sensing technique to monitor for resource reservations by other sidelink UEs and may select resources for sidelink transmissions from unreserved resources. Devices communicating based on sidelink, may determine one or more radio resources in the time and frequency domain that are used by other devices in order to select transmission resources that avoid collisions with other devices. The sidelink transmission and/or the resource reservation may be periodic or aperiodic, where a UE may reserve resources for transmission in a current slot and up to two future slots (discussed below).

Thus, in the second mode (e.g., Mode 2), individual UEs may autonomously select resources for sidelink transmission, e.g., without a central entity such as a base station indicating the resources for the device. A first UE may reserve the selected resources in order to inform other UEs about the resources that the first UE intends to use for sidelink transmission(s).

In some examples, the resource selection for sidelink communication may be based on a sensing-based mechanism. For instance, before selecting a resource for a data transmission, a UE may first determine whether resources have been reserved by other UEs.

For example, as part of a sensing mechanism for resource allocation mode 2, the UE may determine (e.g., sense) whether the selected sidelink resource has been reserved by other UE(s) before selecting a sidelink resource for a data transmission. If the UE determines that the sidelink resource has not been reserved by other UEs, the UE may use the selected sidelink resource for transmitting the data, e.g., in a PSSCH transmission. The UE may estimate or determine which radio resources (e.g., sidelink resources) may be in-use and/or reserved by others by detecting and decoding sidelink control information (SCI) transmitted by other UEs. The UE may use a sensing-based resource selection algorithm to estimate or determine which radio resources are in-use and/or reserved by others. The UE may receive SCI from another UE that includes reservation information based on a resource reservation field comprised in the SCI. The UE may continuously monitor for (e.g., sense) and decode SCI from peer UEs. The SCI may include reservation information, e.g., indicating slots and RBs that a particular UE has selected for a future transmission. The UE may exclude resources that are used and/or reserved by other UEs from a set of candidate resources for sidelink transmission by the UE, and the UE may select/reserve resources for a sidelink transmission from the resources that are unused and therefore form the set of candidate resources. The UE may continuously perform sensing for SCI with resource reservations in order to maintain a set of candidate resources from which the UE may select one or more resources for a sidelink transmission. Once the UE selects a candidate resource, the UE may transmit SCI indicating its own reservation of the resource for a sidelink transmission. The number of resources (e.g., sub-channels per subframe) reserved by the UE may depend on the size of data to be transmitted by the UE. Although the example is described for a UE receiving reservations from another UE, the reservations may also be received from an RSU or other device communicating based on sidelink.

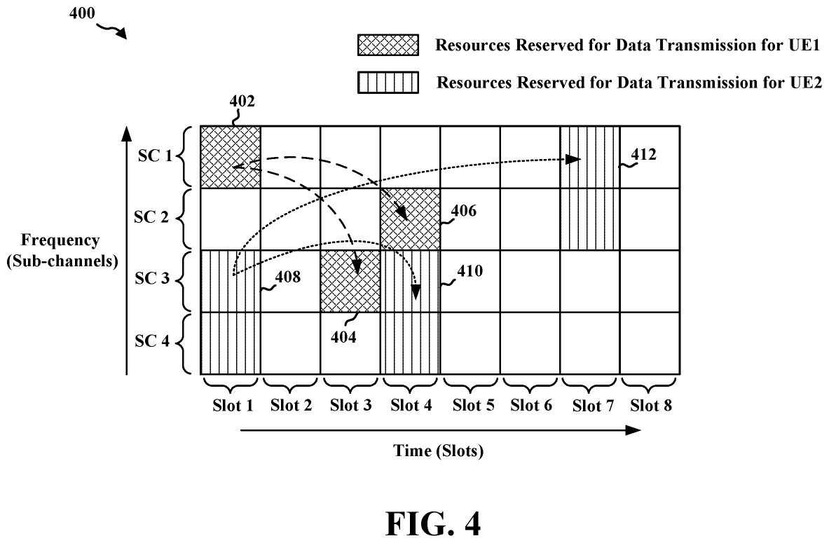

FIG. 4 is an example 400 of time and frequency resources showing reservations for sidelink transmissions. The resources may be comprised in a sidelink resource pool, for example. The resource allocation for each UE may be in units of one or more sub-channels in the frequency domain (e.g., sub-channels SC1 to SC 4), and may be based on one slot in the time domain. The UE may also use resources in the current slot to perform an initial transmission, and may reserve resources in future slots for retransmissions. In this example, two different future slots are being reserved by UE1 and UE2 for retransmissions. The resource reservation may be limited to a window of a pre-defined slots and sub-channels, such as an 8 time slots by 4 sub-channels window as shown in example 400, which provides 32 available resource blocks in total. This window may also be referred to as a resource selection window.

A first UE (“UE1) may reserve a sub-channel (e.g., SC 1) in a current slot (e.g., slot 1) for its initial data transmission 402, and may reserve additional future slots within the window for data retransmissions (e.g., 404 and 406). For example, UE1 may reserve sub-channels SC 3 at slots 3 and SC 2 at slot 4 for future retransmissions as shown by FIG. 4. UE1 then transmits information regarding which resources are being used and/or reserved by it to other UE(s). UE1 may do by including the reservation information in the reservation resource field of the SCI, e.g., a first stage SCI.

FIG. 4 illustrates that a second UE (“UE2”) reserves resources in sub-channels SC 3 and SC 4 at time slot 1 for its current data transmission 408, and reserve first data retransmission 410 at time slot 4 using sub-channels SC 3 and SC 4, and reserve second data retransmission 512 at time slot 7 using sub-channels SC 1 and SC 2 as shown by FIG. 4. Similarly, UE2 may transmit the resource usage and reservation information to other UE(s), such as using the reservation resource field in SCI.

A third UE may consider resources reserved by other UEs within the resource selection window to select resources to transmit its data. The third UE may first decode SCIs within a time period to identify which resources are available (e.g., candidate resources). For example, the third UE may exclude the resources reserved by UE1 and UE2 and may select other available sub-channels and time slots from the candidate resources for its transmission and retransmissions, which may be based on a number of adjacent sub-channels in which the data (e.g., packet) to be transmitted can fit.

While FIG. 4 illustrates resources being reserved for an initial transmission and two retransmissions, the reservation may be for an initial transmission and a single transmission or only for an initial transmission.

The UE may determine an associated signal measurement (such as RSRP) for each resource reservation received by another UE. The UE may consider resources reserved in a transmission for which the UE measures an RSRP below a threshold to be available for use by the UE. A UE may perform signal/channel measurement for a sidelink resource that has been reserved and/or used by other UE(s), such as by measuring the RSRP of the message (e.g., the SCI) that reserves the sidelink resource. Based at least in part on the signal/channel measurement, the UE may consider using/reusing the sidelink resource that has been reserved by other UE(s). For example, the UE may exclude the reserved resources from a candidate resource set if the measured RSRP meets or exceeds the threshold, and the UE may consider a reserved resource to be available if the measured RSRP for the message reserving the resource is below the threshold. The UE may include the resources in the candidate resources set and may use/reuse such reserved resources when the message reserving the resources has an RSRP below the threshold, because the low RSRP indicates that the other UE is distant and a reuse of the resources is less likely to cause interference to that UE. A higher RSRP indicates that the transmitting UE that reserved the resources is potentially closer to the UE and may experience higher levels of interference if the UE selected the same resources.

For example, the UE may determine a set of candidate resources (e.g., by monitoring SCI from other UEs and removing resources from the set of candidate resources that are reserved by other UEs in a signal for which the UE measures an RSRP above a threshold value). Then, the UE may select N resources for transmissions and/or retransmissions of a TB. As an example, the UE may randomly select the N resources from the determined set of candidate resources. For each transmission, the UE may reserve future time and frequency resources for an initial transmission and up to two retransmissions. The UE may reserve the resources by transmitting SCI indicating the resource reservation. For example, in the example in FIG. 4, the UE may transmit SCI reserving resources for data transmissions 408, 410, and 412.

There may be a timeline for a sensing-based resource selection. For example, the UE may sense and decode the SCI received from other UEs during a sensing window, e.g., a time duration prior to resource selection. Based on the sensing history during the sensing window, the UE may be able to maintain a set of available candidate resources by excluding resources that are reserved by other UEs from the set of candidate resources. A UE may select resources from its set of available candidate resources and transmits SCI reserving the selected resources for sidelink transmission (e.g., a PSSCH transmission) by the UE. There may be a time gap between the UE's selection of the resources and the UE transmitting SCI reserving the resources.

In some aspects, the UE may perform congestion control in SL communication using channel busy ratio (CBR) and/or channel occupancy ratio (CR). The CBR may correspond to an estimated number of time-frequency resources observed by a UE as being used by the network divided by the number of the total available time-frequency resources. The CR may correspond to an estimated number of time-frequency resources used by the UE is using divided by the number of total available time-frequency resources.

A UE may perform congestion control, e.g., in order to facilitate more efficient sidelink communication. As part of the congestion control, the UE may limit one or more transmission parameters in order to reduce the congestion that the UE causes to the communication system. For example, the UE may update (e.g., restrict) one or more of: modulation and coding scheme (MCS) indices and tables, number of sub-channels per transmission, number of retransmissions, transmission power, or the like in order to reduce congestion in the communication system by reducing the CR of the UE.

A UE may use CBR as a metric for applying the congestion control procedures by the UE. For example, the UE may estimate or measure the CBR to determine whether the transmission medium is busy. Based on the measured CBR, the UE may limit its own resource utilization, such as by limiting the CR to be smaller than a configured threshold when the measured CBR meets a threshold level. To estimate the CBR, the UE may perform RSSI measurements. For example, for PSSCH, the CBR measurement may be based on the fraction of sub-channels for which the UE measures an S-RSSI that exceeds a configured threshold. In some aspects, in order to compute the CBR at slot n, the UE may measure the RSSI for all sub-channels between [n−100, n−1], or for the last 100 ms. The CBR indicates how much of the transmission medium is being used by UEs in the communication system. The CR may correspond to an amount of resources used by a particular UE, e.g., the UE measuring the CBR and applying congestion control. The CR may be based on the fraction of sub-channels used for transmission in slots [n−a, n−1] and granted/reserved in slots [n, n+b], where a is a positive integer and b is a non-negative integer. For example, a+b+1 may be 1000 and a may be greater than or equal to 500. In some aspects, evaluating the CR measurement at slot n may be defined as the total number of sub-channels used over slots [n−a, n+b] divided by the total number of configured sub-channels in the transmission pool over slots [n−a, n+b]. In some aspects, the UE may drop a transmission in a slot n in response to the CR evaluated in slot n being greater than the CR limit. The UE may use the CBR and the CR to control congestion in a wireless communication system through sidelink resource allocation for sidelink transmissions.

Full-duplex communication supports transmission and reception of information over a same frequency band in manner that overlap in time. In this manner, spectral efficiency may be improved with respect to the spectral efficiency of half-duplex communication, which supports transmission or reception of information in one direction at a time without overlapping uplink and downlink communication. A UE operating in a half-duplex mode does not sense the sub-channels, e.g., or perform RSSI measurements, at the times at which the UE transmits. Aspects presented herein provide techniques for a UE to apply in congestion control and CBR measurement for times at which the UE transmits in a half-duplex mode. The aspects presented herein enable a unified CBR calculation that may be applied for UEs operating in different modes, e.g., in full-duplex mode and in half-duplex mode. The aspects enable UE that may not sense/measure RSSI during at least a subset of time resources to determine a CBR in a unified manner with other UEs that perform uninterrupted sensing.

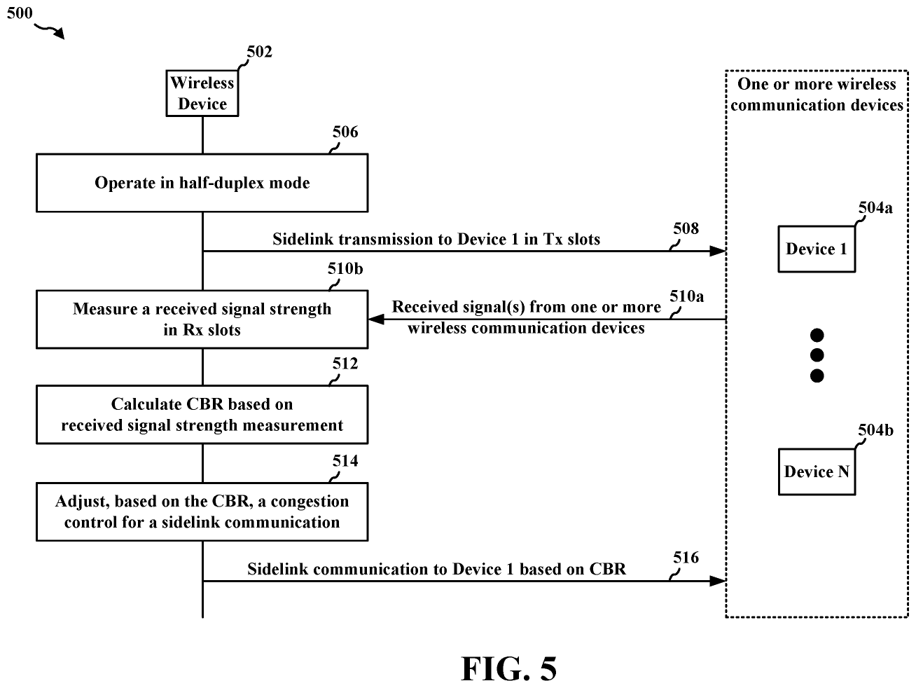

FIG. 5 is a call flow diagram 500 illustrating communications between wireless devices that support sidelink communication. A wireless device 502 may be configured to operate, at 506, in a half-duplex mode. That is, the wireless device may not receive communications while the wireless device 502 is also transmitting. For example, the wireless device 502 may transmit, at 508, a sidelink transmission to Device 1 404a, e.g., in Tx slots.

The wireless device 502 may receive, at 510a, received signal(s) from one or more wireless communication devices to measure, at 510b, a received signal strength in Rx slots from any number of wireless communication devices included in Device 1 504a through Device N 504b. The received signal strength measurement (e.g., received signal strength indicator (RSSI) measurement) may be indicative of a CBR over a combined set of slots including at least one of a first set of transmit slots and a second set of receive slots. At 512, the wireless device 502 may calculate the CBR based on the received signal strength measurement.

The wireless device 502 may also be configured to adjust, at 514, based on the calculated CBR, a congestion control for a subsequent sidelink communication. For example, the wireless device 502 may adjust the congestion control, at 514, by enabling the congestion control if the CBR associated with both the first set of transmit slots and the second set of receive slots exceeds an RSSI threshold. In further aspects, the wireless device 502 may adjust the congestion control, at 514, by disabling the congestion control if the CBR associated with both the first set of transmit slots and the second set of receive slots is below an RSSI threshold. At 516, the wireless device 502 may transmit a sidelink communication to Device 1 504a, e.g., based on the adjustment, at 514, of the congestion control and/or the calculation, at 512, of the CBR.

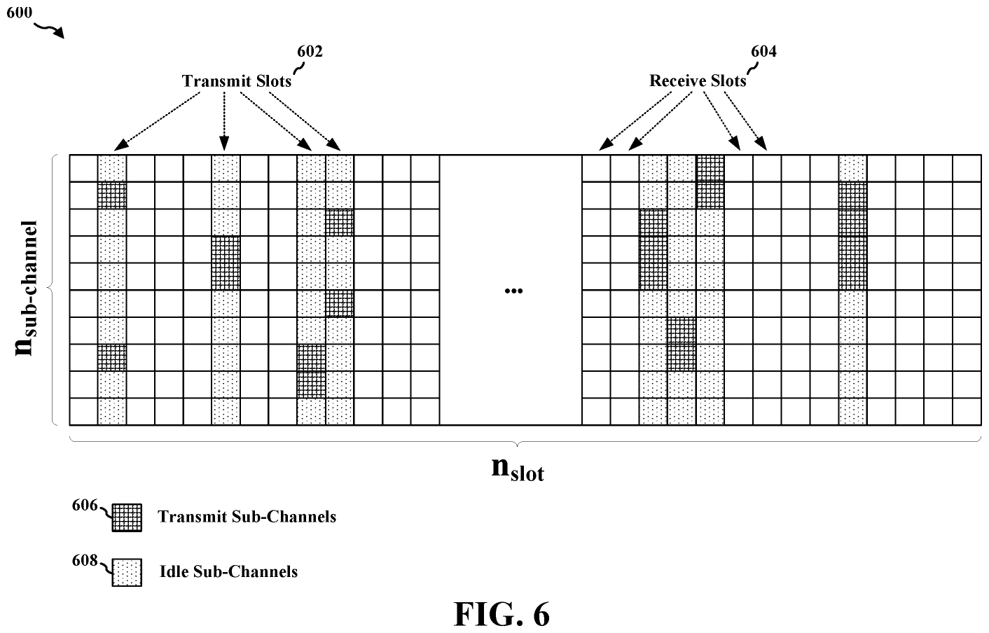

FIG. 6 illustrates a slot diagram 600 having a total number of slots nₛₗₒₜ that include both transmit slots 602 and receive slots 604. The receive slots 604 correspond to all the slots in the slot diagram 600 that do not include a hatch pattern and the transmit slots 602 correspond to all the slots in the slot diagram 600 that do include a hatch pattern.

A CBR for a channel between two sidelink devices may be determined based on an RSSI measurement over the receive slots 604. The CBR for a subframe n may be defined differently for a CBR associated with a PSSCH than for a CBR associated with a PSCCH. For example, a CBR associated with a PSSCH may correspond to a portion of sub-channels in a resource pool having a sidelink RSSI (S-RSSI) measured by a UE that exceeds, or meets, a configured/pre-configured threshold sensed, e.g., over subframes [n−100, n−1]. For a CBR associated with a PSCCH, the CBR may correspond to a portion of resources in a PSCCH pool having an S-RSSI measured by a UE that exceeds a configured/pre-configured threshold sensed, e.g., over subframes [n−100, n−1], which may assume that the PSCCH pool is comprised of resources that have a size of two consecutive PRB pairs in the frequency domain. The pool may be configured/pre-configured such that the PSCCH may be transmitted with a corresponding PSSCH in non-adjacent RBs. As an example, meeting a threshold of 11 may correspond to exceeding a threshold of 10.

The CBR may be determined and reported on a per UE basis. In further aspects, a sidelink CBR that is measured in slot n may be defined as a portion of sub-channels in a resource pool having an S-RSSI measured by a UE that exceeds a configured/pre-configured threshold sensed over a CBR measurement window [n−a, n−1], where a is equal to 100 or 100-2 slots based on a higher layer parameter, such as sl-TimeWindowSizeCBR. Thus, the UE may measure the RSSI over a time window (e.g., slots or subframes [n−100, n−1]) and, based on a defined threshold, each UE may determine the CBR. The time window is not limited to a fixed value of 100 slots or subframes. For example, in NR applications the slot/subframe length/duration may vary based on the numerology. As an example, in an LTE application the slot/subframe length/duration may be regarded as 100 slots/subframes. In an example that includes a length/duration of 100 slots for nₛₗₒₜ, if 30 slots have a received signal strength that is greater than the defined threshold, the CBR would be reported as being at 30 percent. The CBR also may be reported to the network. In examples, the CBR may be used for vehicle-to-everything (V2X) applications associated with RRC_IDLE intra-frequency procedures, RRC_IDLE inter-frequency procedures, RRC_CONNECTED intra-frequency procedures, RRC_CONNECTED inter-frequency procedures, etc.

The S-RSSI may correspond to a linear average of a total received power in watts per SC-FDMA symbol sensed by the UE over a configured sub-channel in SC-FDMA symbols 1, 2, . . . , 6 of a first slot and SC-FDMA symbols 0, 1, . . . , 5 of a second slot of a subframe. The RSSI may be measured by the UE in each of the receive slots 604 slot. The UE may measure the received strength of the signal and determine whether the received strength is larger than a defined RSSI threshold. An antenna connector of the UE may be used as a reference point for the S-RSSI. If receiver diversity is being implemented by the UE, the reported value may not be lower than the corresponding S-RSSI of any of the individual diversity branches.

If further aspects, the S-RSSI may correspond to a linear average of a total received power in watts sensed by the UE over the configured sub-channel in OFDM symbols of a slot configured for PSCCH and PSSCH (e.g., beginning from the second OFDM symbol). For FR1, a reference point for the S-RSSI may be an antenna connector of the UE. For FR2, the S-RSSI may be measured based on a combined signal from antenna elements that correspond to a particular receiver branch. If receiver diversity is implemented by the UE for FR1 or FR2, the reported S-RSSI value may not be lower than the corresponding S-RSSI of any of the individual receiver branches. Such aspects may be indicative of a particular channel and starting OFDM symbol over time. In examples, the RSSI may be used for V2X applications associated with RRC_IDLE intra-frequency procedures, RRC_IDLE inter-frequency procedures, RRC_CONNECTED intra-frequency procedures, RRC_CONNECTED inter-frequency procedures, etc.

While the RSSI for sidelink is to be measured over a time window, half-duplex configurations may cause the UE to be unable to receive an incoming signal while the UE is transmitting an outgoing signal. That is, the UE may not be able to receive an incoming signal during the transmit slots 602. The half-duplex configuration may be assumed to be a default configuration of the UE. Thus, when the UE transmits a packet during a duty cycle, the UE may not be able to measure the RSSI during the transmit slots 602. In the example of the 100-slot time window, if the UE transmits during 5 slots of the 100 slots, the UE may only measure the RSSI in the remaining 95 slots. Hence, the UE may determine to count the 5 transmit slots, designate the 5 transmit slots as busy, or disregard the 5 transmit slots and evaluate the remaining 95 slots. Without a central scheduler, each UE may have different transmit times and/or different receive times during the time window. Even though the length of the time window may be the same for each UE, the transmit occasions for the UEs may be different.

Accordingly, RSSI measurement procedures for CBR determinations may have to account for half-duplex configurations, where the UE may not sense the sub-channels of the transmit slots 602. That is, no RSSI measurement may be available to the UE while the UE is transmitting. In some cases, such considerations may also be applicable to self-interference limited full-duplex UEs in addition to half-duplex UEs. A congestion control of the UE may be adjusted based on the determined CBR. The impact on the congestion control behavior may be less significant for low duty cycles. For example, a 1-2% difference in the CBR may not trigger a significant change in the congestion control behavior of the UE. The CBR may serves as an indicator of whether congestion control behaviors of the UE are to be enabled. For example, congestion control may be enabled if the determined CBR is high, and may improve sidelink communications such as communications associated with V2X procedures.

For higher duty cycle applications (e.g., RSU applications), a 20 percent duty cycle may correspond to a 20 percent uncertain in the CBR due to the half-duplex constraint. A transmission rate associated with some devices, such as an RSU, may be significantly higher than a transmission rate associated with UEs and/or vehicles. A CBR of 20 percent may indicate that the RSU transmits in the transmit slots 602 during 20 percent of the time window and may only measure RSSI during the remaining 80 percent of the time window, which may cause a reporting bias. Two different RSUs that follow two different implementations may have different measured CBRs (e.g., based on whether the 20 percent transmit time is considered for the CBR determination). RSUs and other V2X devices may also be constrained by channel occupancy ratio (CR) limits. As such, congestion control procedures may be implemented such that all UEs may operate with the same congestion control behavior based on unified CBR calculation protocols.

A total number of slots in the time window may be indicated via nₛₗₒₜ, which may be based on the numerology. The number of sub-channels in the frequency domain may be indicated via n_{sub-channel}. The total number of slots nₛₗₒₜ may correspond to the total time window for measuring the RSSI and determining the CBR. For example, if the SCS is 15 kHz, the total time window may be 100 slots and the number of sub-channels may be 10 sub-channels. The bandwidth may include 100 RBs, which may correspond to a sub-channel size of 10 sub-channels (i.e., 10 RBs per sub-channel). The UE may measure the RSSI for each sub-channel in each of the receive slots 604, and calculate the CBR based on the predefined/preconfigured RSSI threshold.

The total number of slots nₛₗₒₜ may include a first number of transmit slots 602 (e.g., n_{Tx_slot}) and a second number of remaining slots/receive slots 604 that correspond to nₛₗₒₜ−n_{Tx_slot}. Assuming that no RSSI measurement is performed while the UE transmits in the transmit slots 602, the number of total busy sub-channels may be indicated via n_{slot,sub-channel}^{busy}. In an example, the number of busy slots may correspond to 20 slots and the number of non-busy slots may correspond to 80 slots. Based on having 10 sub-channels per slot, multiplied by 80 non-busy slots, the UE may have 900 non-busy sub-channels among all of the slots in the time window to measure the RSSI, and 200 sub-channels that are busy.

In a first aspect, a wireless device that supports sidelink communication may not count the first number of transmit slots 602 (e.g., n_{Tx_slot}) as busy. The wireless device may also normalize the number of slots. That is, the wireless device may determine the CBR based on the second number of remaining slots/receive slots 604 nₛₗₒₜ−n_{Tx_slot} (e.g., 80 slots). A first CBR may be calculated based on

$${cbr}^{1} = \frac{{n}_{s lot , sub - channel}^{busy}}{( {n}_{slot} - {n}_{{Tx}_{slot}} ) * {n}_{sub - channel}} ,$$

wherein the numerator corresponds to the total number of busy sub-channels over time (e.g., at each slot) and the denominator is indicative of no RSSI measurement in the first number of transmit slots 602 (e.g., n_{Tx_slot}). In other words, the second number of remaining slots/receive slots 604 (e.g., nₛₗₒₜ−n_{Tx_slot}) may be used to calculate the CBR.

In a second aspect, the wireless device that supports sidelink communication may similarly not count the first number of transmit slots 602 (e.g., n_{Tx_slot}) as busy. However, the wireless device may determine to not normalize the number of slots. That is, the wireless device may determine the CBR based on the total number of slots nₛₗₒₜ (e.g., all 100 slots). A second CBR may be calculated based on

$${cbr}^{2} = \frac{{n}_{s lot , sub - channel}^{busy}}{{n}_{slot} * {n}_{sub - channel}} ,$$

where the numerator still corresponds to the total number of busy sub-channels over all the slots, even though for a certain percentage of time (e.g., 20 percent of the time) the RSSI measurement is not available. The denominator corresponds to the total number of sub-channels over all the slots in the time window (e.g., 100 slots×10 sub-channels).

In a third aspect, the wireless device that supports sidelink communication may count a third number of transmit sub-channels 606 as busy. The wireless device may also determine to not normalize the number of slots. That is, the wireless device may determine the CBR based on the total number of sub-channels in the slot diagram 600. A third CBR may be calculated based on

$${cbr}^{3} = \frac{{n}_{s lot , sub - channel}^{busy} + {n}_{Tx \_ slot} * {n}_{sub - channel}}{{n}_{slot} * {n}_{sub - channel}} ,$$

where the third number of transmit sub-channels 606 is regarded as busy. Further, a certain number of transmit slots n_{Tx_slot} (e.g., 20 slots) may be regarded as busy, even though the RSSI measurement is not available in the slots. The total number of busy sub-channels in the numerator corresponds to the measured busy sub-channels—the number of busy transmit slots (e.g., 20 slots×10 sub-channels). The denominator is similar to the second aspect and corresponds to the total number of sub-channels over all the slots (e.g., 100 slots×10 sub-channels).

In a fourth aspect, the wireless device that supports sidelink communication may count the transmit sub-channels 606 as busy, count idle sub-channels 608 in the same slot as not busy, and not normalize the number of slots. A fourth CBR may be calculated based on

$${cbr}^{4} = \frac{{n}_{Tx \_ slot} * {n}_{sub - channel} * beta}{{n}_{slot} * {n}_{sub - channel}} ,$$

where beta corresponds to a ratio of sub-channels that the wireless device does not use/transmit in. That is, the transmit slots 602 may include a first number of sub-channels that wireless device actually uses to transmit (e.g., transmit sub-channels 606) and a second number of sub-channels (e.g., idle sub-channels 608) that the wireless device regards as busy, where the first number of sub-channels and the second number of sub-channels are collocated in the same transmit slot. Thus, the transmit resources may be differentiated from the non-transmit resources within the transmit slots 602. For example, the wireless device may transmit in the first number of sub-channels, but in the second number of sub-channels there may be no data to transmit. The wireless device still cannot receive in the second number of sub-channels, so the wireless device may regard the second number of sub-channels as idle. Thus, in the fourth aspect, the wireless device may count the number of actual transmit slots 602, where the beta factor is indicative of a number of sub-channels that the wireless device does not use to transmit (e.g., idle sub-channels 608).

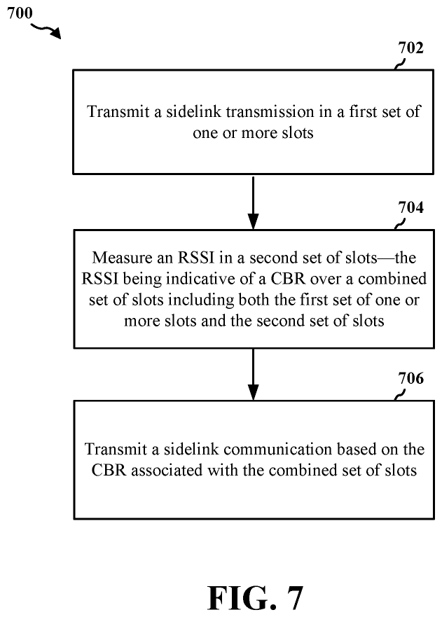

FIG. 7 is a flowchart 700 of a method of wireless communication. The method may be performed by a wireless device that supports sidelink communication (e.g., the UE 104; the RSU 107; wireless device 310, 350, 502; the apparatus 902; etc.), which may include the memory 360 and which may be the entire wireless device or a component of the wireless device, such as the TX processor 368, the RX processor 356, and/or the controller/processor 359. In examples, the method may be performed to reduce congestion in a sidelink communication environment and to provide a more consistent CBR calculation for various modes of operation, e.g., including half-duplex operation, full-duplex operation, etc.

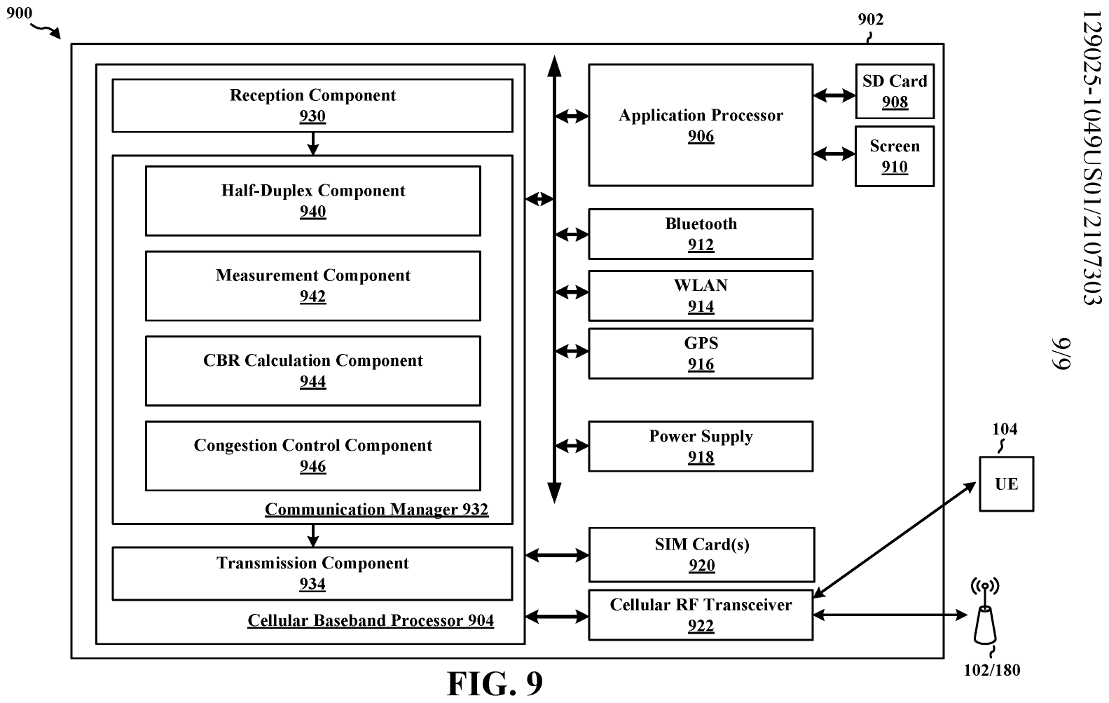

At 702, the wireless device may transmit a sidelink transmission in a first set of one or more slots. For example, referring to FIGS. 5-5, the wireless device 502 may transmit, at 508, a sidelink to transmission to Device 1 404a in Tx slots. In the slot diagram 600, the wireless device may transmit in the transmit slots 602. The transmission may be performed, e.g., by the transmission component 934 and/or the half-duplex component 940 of the apparatus 902 in FIG. 9.

At 704, the wireless device may measure strengthen RSSI in a second set of slots—the RSSI being is indicative of a CBR over a combined set of slots including both the first set of one or more slots and the second set of one or more slots. For example, referring to FIGS. 5-5, the wireless device 502 may measure, at 410b, a received signal strength in Rx slots based on received signal(s), at 410a, from one or more wireless communication devices. In the slot diagram 600, the wireless device may perform an RSSI measurement in the receive slots 604 for determining a CBR. The measurement may be performed, e.g., by the measurement component 942 of the apparatus 902 in FIG. 9.

At 706, the wireless device may transmit a sidelink communication based on the CBR associated the combined set of slots. For example, referring to FIG. 5, the wireless device 502 may transmit, at 516, the sidelink communication to Device 1 404a based on the CBR calculated at, 512. The transmission may be performed, e.g., by the transmission component 934 based on a calculation by the CBR calculation component 944 of the apparatus 902 in FIG. 9.

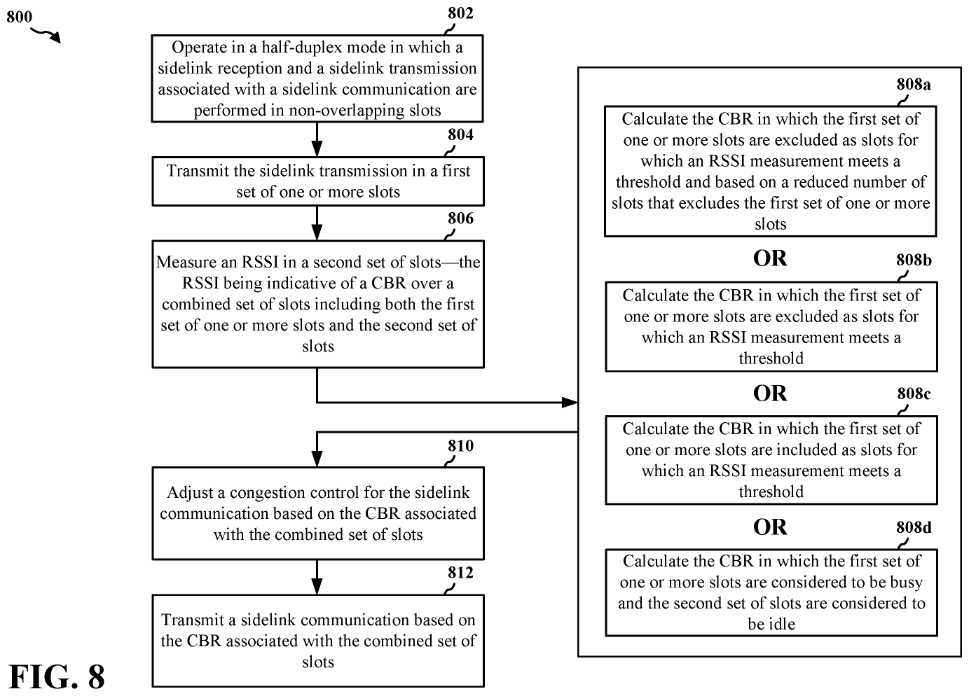

FIG. 8 is a flowchart 800 of a method of wireless communication. The method may be performed by a wireless device that supports sidelink communication (e.g., the UE 104, wireless device 502, the apparatus 902, etc.), which may include the memory 360 and which may be the entire wireless device or a component of the wireless device, such as the TX processor 368, the RX processor 356, and/or the controller/processor 359. In examples, the method may be performed to reduce congestion in a sidelink communication environment and to provide a more consistent CBR calculation for various modes of operation, e.g., including half-duplex operation, full-duplex operation, etc.

At 802, the wireless device may operate in a half-duplex mode in which a sidelink reception and a sidelink transmission associated with a sidelink communication are performed in non-overlapping slots. For example, referring to FIGS. 5-5, the wireless device 502 may operate, at 506, in a half-duplex mode. In the slot diagram 600, the wireless device may not be configured to receive in the transmit slots 602. The half-duplex operation may be performed, e.g., by the half-duplex component 940 of the apparatus 902 in FIG. 9.

At 804, the wireless device may transmit the sidelink transmission in a first set of one or more slots. For example, referring to FIGS. 5-5, the wireless device 502 may transmit, at 508, a sidelink to transmission to Device 1 404a in Tx slots. In the slot diagram 600, the wireless device may transmit in the transmit slots 602. The transmission may be performed, e.g., by the transmission component 934 and/or the half-duplex component 940 of the apparatus 902 in FIG. 9.

At 806, the wireless device may measure an RSSI in a second set of slots the RSSI may be indicative of a CBR over a combined set of slots including both the first set of one or more slots and the second set of slots. For example, referring to FIGS. 5-5, the wireless device 502 may measure, at 410b, a received signal strength in Rx slots based on received signal(s), at 410a, from one or more wireless communication devices. In the slot diagram 600, the wireless device may perform an RSSI measurement in the receive slots 604 for determining a CBR. The measurement may be performed, e.g., by the measurement component 942 of the apparatus 902 in FIG. 9.

At 808a, the wireless device may calculate the CBR in which the first set of one or more slots are excluded as slots for which an RSSI measurement exceeds a threshold and based on a reduced number of slots that excludes the first set of one or more slots. For example, referring to FIG. 5, the wireless device 502 may calculate, at 512, the CBR based on the received signal strength measurement. The CBR may be based on a ratio between a first number of sub-channels having the RSSI measurement exceeding the threshold during the second set of slots and a number of slots in the second set of slots multiplied by a number of sub-channels in a frequency domain. The calculation may be performed, e.g., by the CBR calculation component 944 of the apparatus 902 in FIG. 9.

At 808b, the wireless device may alternatively calculate the CBR in which the first set of one or more slots are excluded as slots for which an RSSI measurement exceeds a threshold. For example, referring to FIG. 5, the wireless device 502 may calculate, at 512, the CBR based on the received signal strength measurement. The CBR may be based on a ratio between a first number of sub-channels having the RSSI measurement that exceeds the threshold during the second set of slots and a number of slots in the combined set of slots multiplied by a number of sub-channels in a frequency domain. The calculation may be performed, e.g., by the CBR calculation component 944 of the apparatus 902 in FIG. 9.

At 808c, the wireless device may alternatively calculate the CBR in which the first set of one or more slots are included as slots for which an RSSI measurement exceeds a threshold. For example, referring to FIG. 5, the wireless device 502 may calculate, at 512, the CBR based on the received signal strength measurement. The CBR may be based on a ratio between: a first number of sub-channels having the RSSI measurement that exceeds the threshold during the second set of slots, and a number of slots in the combined set of slots multiplied by a number of sub-channels in a frequency domain. The calculation may be performed, e.g., by the CBR calculation component 944 of the apparatus 902 in FIG. 9.

At 808d, the wireless device may alternatively calculate the CBR in which the first set of one or more slots are considered to be busy and the second set of slots are considered to be idle. For example, referring to FIG. 5, the wireless device 502 may calculate, at 512, the CBR based on the received signal strength measurement. The CBR may be based on a ratio between: a number of one or more sub-channels in a frequency domain over the first set of one or more slots multiplied by a beta parameter associated with one or more idle sub-channels in the first set of one or more slots, and a number of slots in the combined set of slots multiplied by the number of the one or more sub-channels in the frequency domain. The beta parameter may correspond to an additional ratio between the idle sub-channels in the first set of one or more slots and the number of sub-channels in the frequency domain over the first set of one or more slots. The calculation may be performed, e.g., by the CBR calculation component 944 of the apparatus 902 in FIG. 9.

At 810, the wireless device may adjust a congestion control for the sidelink communication based on the CBR associated with the combined set of slots. For example, referring to FIG. 5, the wireless device 502 may adjust, at 514, based on the CBR, a congestion control for a sidelink communication. In a first aspect, adjusting the congestion control, at 514, may include enabling the congestion control based on the CBR associated with the combined set of slots exceeding an RSSI threshold. In a second aspect, adjusting the congestion control, at 514, may include disabling the congestion control based on the CBR associated with the combined set of slots being below an RSSI threshold. The adjustment may be performed, e.g., by the congestion control component 946 of the apparatus 902 in FIG. 9.

At 812, the wireless device may transmit the sidelink communication based on the CBR associated with the combined set of slots. For example, referring to FIG. 5, the wireless device 502 may transmit, at 516, the sidelink communication to Device 1 404a based on the CBR calculated at, 512. The transmission may be performed, e.g., by the transmission component 934 based on a calculation by the CBR calculation component 944 of the apparatus 902 in FIG. 9.

FIG. 9 is a diagram 900 illustrating an example of a hardware implementation for an apparatus 902. The apparatus 902 may be a UE, a component of a UE, or may implement UE functionality. The apparatus may be an RSU, a component of an RSU, or may implement RSU functionality. The apparatus may be a device other than a UE or RSU that supports sidelink communication. In some aspects, the apparatus 802 may include a baseband processor 904 (also referred to as a modem) coupled to a RF transceiver 922. In some aspects, the baseband processor 904 may be a cellular baseband processor, and the RF transceiver 922 may be a cellular RF transceiver. In some aspects, the apparatus 902 may further include one or more subscriber identity modules (SIM) cards 920, an application processor 906 coupled to a secure digital (SD) card 908 and a screen 910, a Bluetooth module 912, a wireless local area network (WLAN) module 914, a Global Positioning System (GPS) module 916, or a power supply 918. The baseband processor 904 communicates through the RF transceiver 922 with the UE 104 and/or BS 102/180. The baseband processor 904 may include a computer-readable medium/memory. The computer-readable medium/memory may be non-transitory. The baseband processor 904 is responsible for general processing, including the execution of software stored on the computer-readable medium/memory. The software, when executed by the baseband processor 904, causes the baseband processor 904 to perform the various functions described supra. The computer-readable medium/memory may also be used for storing data that is manipulated by the baseband processor 904 when executing software. The baseband processor 904 further includes a reception component 930, a communication manager 932, and a transmission component 934. The communication manager 932 includes the one or more illustrated components. The components within the communication manager 932 may be stored in the computer-readable medium/memory and/or configured as hardware within the baseband processor 904. The baseband processor 904 may be a component of the device 350 and may include the memory 360 and/or at least one of the TX processor 368, the RX processor 356, and the controller/processor 359. In one configuration, the apparatus 902 may be a modem chip and include just the baseband processor 904, and in another configuration, the apparatus 902 may be the entire UE (e.g., see 350 of FIG. 3) and include the additional modules of the apparatus 902.

The communication manager 932 includes a half-duplex component 940 that is configured, e.g., as described in connection with 802, to operate in a half-duplex mode in which a sidelink reception and a sidelink transmission associated with a sidelink communication are performed in non-overlapping slots. The communication manager 932 further includes a measurement component 942 that is configured, e.g., as described in connection with 704 and 806, to measure strengthen RSSI in a second set of slots—the received signal strength is indicative of a CBR over a combined set of slots including both the first set of one or more slots and the second set of one or more slots. The communication manager 932 further includes a CBR calculation component 944 that is configured, e.g., as described in connection with 808a, 808b, 808c, and 808d, to calculate the CBR in which the first set of one or more slots are excluded as slots for which an RSSI measurement exceeds a threshold and based on a reduced number of slots that excludes the first set of one or more slots; to calculate the CBR in which the first set of one or more slots are excluded as slots for which an RSSI measurement exceeds a threshold; to calculate the CBR in which the first set of one or more slots are included as slots for which an RSSI measurement exceeds a threshold; and to the CBR in which the first set of one or more slots are considered to be busy and the second set of slots are considered to be idle. The communication manager 932 further includes a congestion control component 946 that is configured, e.g., as described in connection with 810, to adjust a congestion control for the sidelink communication based on the CBR associated with the combined set of slots.

The transmission component 934 is configured, e.g., as described in connection with 702, 706, 804, and 812, to transmit the sidelink transmission in a first set of one or more slots; and to transmit the sidelink communication based on the CBR associated with the combined set of slots.

The apparatus may include additional components that perform each of the blocks of the algorithm in the flowcharts of FIGS. 7-7. As such, each block in the flowcharts of FIGS. 7-7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 902 may include a variety of components configured for various functions. In one configuration, the apparatus 902, and in particular the baseband processor 904, includes means for transmitting a sidelink transmission in a first set of one or more slots; means for measuring strengthen RSSI in a second set of slots, the RSSI being indicative of a CBR over a combined set of slots including both the first set of one or more slots and the second set of one or more slots; and means for transmitting a sidelink communication based on the CBR associated with the combined set of slots. The apparatus 902 further includes means for calculating the CBR in which the first set of one or more slots are not included as slots for which the received signal strength measurement exceeds a threshold and based on a reduced set of slots that does not include the first set of one or more slots. The apparatus 902 further includes means for calculating the CBR in which the first set of one or more slots are not included as slots for which the received signal strength measurement exceeds a threshold. The apparatus 902 further includes means for calculating the CBR in which the first set of one or more slots are included as slots for which the received signal strength measurement exceeds a threshold. The apparatus 902 further includes means for calculating the CBR in which the first set of one or more slots are considered to be busy and the second set of one or more slots are considered to be idle.

The apparatus 902 further includes means for adjusting a congestion control for the sidelink communication based on the CBR associated with both the first set of one or more slots and the second set of one or more slots. The means for adjusting the congestion control may be further configured to enable the congestion control if the CBR associated with both the first set of one or more slots and the second set of one or more slots exceeds an RSSI threshold. The means for adjusting the congestion control may be further configured to disable the congestion control if the CBR associated with both the first set of one or more slots and the second set of one or more slots is below an RSSI threshold. The apparatus 902 further includes means for operating in a half-duplex mode in which a sidelink reception and a sidelink transmission associated with the sidelink communication are performed in non-overlapping slots.

The means may be one or more of the components of the apparatus 902 configured to perform the functions recited by the means. As described supra, the apparatus 902 may include the TX Processor 368, the RX Processor 356, and the controller/processor 359. As such, in one configuration, the means may be the TX Processor 368, the RX Processor 356, and the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is a method of wireless communication at a wireless device that supports sidelink communication, comprising: transmitting a sidelink transmission in a first set of one or more slots; measuring a received signal strength indicator (RSSI) in a second set of slots, the RSSI indicative of a channel busy ratio (CBR) over a combined set of slots including both the first set of one or more slots and the second set of slots; and transmitting the sidelink communication based on a CBR associated with the combined set of slots.

Aspect 2 may be combined with aspect 1 further includes calculating the CBR in which the first set of one or more slots are excluded as slots for which an RSSI measurement exceeds a threshold and based on a reduced number of slots that excludes the first set of one or more slots.

Aspect 3 may be combined with any of aspects 1-2 and includes that the CBR is based on a ratio between a first number of sub-channels having the RSSI measurement exceeding the threshold during the second set of slots and a number of slots in the second set of slots multiplied by a number of sub-channels in a frequency domain.

Aspect 4 may be combined with aspect 1 and further includes calculating the CBR in which the first set of one or more slots are excluded as slots for which an RSSI measurement exceeds a threshold.

Aspect 5 may be combined with any of aspects 1 or 4 and includes that the CBR is based on a ratio between a first number of sub-channels having the RSSI measurement that exceeds the threshold during the second set of slots and a number of slots in the combined set of slots multiplied by a number of sub-channels in a frequency domain.

Aspect 6 may be combined with aspect 1 and further includes calculating the CBR in which the first set of one or more slots are included as slots for which an RSSI measurement exceeds a threshold.

Aspect 7 may be combined with any of aspects 1 or 6 and includes that the CBR is based on a ratio between: first number of sub-channels having the RSSI measurement that exceeds the threshold during the second set of slots, and a number of slots in the combined set of slots multiplied by a number of sub-channels in a frequency domain.

Aspect 8 may be combined with aspect 1 and further includes calculating the CBR in which the first set of one or more slots are considered to be busy and the second set of slots are considered to be idle.

Aspect 9 may be combined with any of aspects 1 or 8 and includes that the CBR is based on a ratio between: a number of one or more sub-channels in a frequency domain over the first set of one or more slots multiplied by a beta parameter associated with one or more idle sub-channels in the first set of one or more slots, and a number of slots in the combined set of slots multiplied by the number of the one or more sub-channels in the frequency domain.

Aspect 10 may be combined with any of aspects 1 or 8-9 and includes that the beta parameter corresponds to an additional ratio between the one or more idle sub-channels in the first set of one or more slots and the number of one or more sub-channels in the frequency domain over the first set of one or more slots.

Aspect 11 may be combined with any of aspects 1-10 and further includes adjusting a congestion control for the sidelink communication based on the CBR associated with the combined set of slots.

Aspect 12 may be combined with any of aspects 1-11 and includes that adjusting the congestion control further includes enabling the congestion control based on the CBR associated with the combined set of slots exceeding an RSSI threshold.

Aspect 13 may be combined with any of aspects 1-12 and includes that adjusting the congestion control further includes disabling the congestion control based on the CBR associated with the combined set of slots being below an RSSI threshold.

Aspect 14 may be combined with any of aspects 1-13 and further includes operating in a half-duplex mode in which a sidelink reception and the sidelink transmission associated with the sidelink communication are performed in non-overlapping slots.

Aspect 15 is an apparatus for wireless communication including memory and at least one processor coupled to the memory, the memory and the at least one processor configured to perform the method of any of aspects 1-14.

In Aspect 16, the apparatus of aspect 15 further includes at least one antenna coupled to the at least one processor.

In aspect 17, the apparatus of aspect 15 or aspect 16 further includes a transceiver coupled to the at least one processor.

Aspect 18 is an apparatus for wireless communication including means for performing the method of any of aspects 1-14.

In Aspect 19, the apparatus of aspect 18 further includes at least one antenna coupled to the means to perform the method of any of aspects 1-14.

In aspect 20, the apparatus of aspect 18 or aspect 19 further includes a transceiver coupled to the means to perform the method of any of aspects 1-14.

Aspect 17 is a non-transitory computer-readable storage medium storing computer executable code, the code when executed by at least one processor causes the at least one processor to perform the method of any of aspects 1-14.

What is claimed is:

1. An apparatus for wireless communication at a wireless device that supports sidelink communication, comprising:
a memory; and
at least one processor coupled to the memory, the memory and the at least one processor configured to:
transmit a sidelink transmission in a first set of one or more slots;
measure a received signal strength indicator (RSSI) in a second set of slots, the RSSI indicative of a channel busy ratio (CBR) over a combined set of slots including both the first set of one or more slots and the second set of slots; and
transmit the sidelink communication based on the CBR associated with the combined set of slots.

2. The apparatus of claim 1, wherein the memory and the at least one processor are further configured to:
calculate the CBR in which the first set of one or more slots are excluded as slots for which an RSSI measurement exceeds a threshold and based on a reduced number of slots that excludes the first set of one or more slots.

3. The apparatus of claim 2, wherein the CBR is based on a ratio between:
a first number of sub-channels having the RSSI measurement exceeding the threshold during the second set of slots, and
a number of slots in the second set of slots multiplied by a number of sub-channels in a frequency domain.

4. The apparatus of claim 1, wherein the memory and the at least one processor are further configured to:
calculate the CBR in which the first set of one or more slots are excluded as slots for which an RSSI measurement exceeds a threshold.

5. The apparatus of claim 4, wherein the CBR is based on a ratio between a first number of sub-channels having the RSSI measurement that exceeds the threshold during the second set of slots and a number of slots in the combined set of slots multiplied by a number of sub-channels in a frequency domain.

6. The apparatus of claim 1, wherein the memory and the at least one processor are further configured to:
calculate the CBR in which the first set of one or more slots are included as slots for which an RSSI measurement exceeds a threshold.

7. The apparatus of claim 6, wherein the CBR is based on a ratio between:
a first number of sub-channels having the RSSI measurement that exceeds the threshold during the second set of slots, and
a number of slots in the combined set of slots multiplied by a number of sub-channels in a frequency domain.

8. The apparatus of claim 1, wherein the memory and the at least one processor are further configured to:
calculate the CBR in which the first set of one or more slots are considered to be busy and the second set of slots are considered to be idle.

9. The apparatus of claim 1, wherein the CBR is based on a ratio between:
a number of one or more sub-channels in a frequency domain over the first set of one or more slots multiplied by a beta parameter associated with one or more idle sub-channels in the first set of one or more slots, and
a number of slots in the combined set of slots multiplied by the number of the one or more sub-channels in the frequency domain.

10. The apparatus of claim 9, wherein the beta parameter corresponds to an additional ratio between the one or more idle sub-channels in the first set of one or more slots and the number of one or more sub-channels in the frequency domain over the first set of one or more slots.

11. The apparatus of claim 1, wherein the memory and the at least one processor are further configured to adjust a congestion control for the sidelink communication based on the CBR associated with the combined set of slots.

12. The apparatus of claim 11, wherein, to adjust the congestion control, the memory and the at least one processor are further configured to enable the congestion control based on the CBR associated with the combined set of slots exceeding an RSSI threshold.

13. The apparatus of claim 11, wherein, to adjust the congestion control, the memory and the at least one processor are further configured to disable the congestion control based on the CBR associated with the combined set of slots being below an RSSI threshold.

14. The apparatus of claim 1, further comprising at least one antenna coupled to the at least one processor, wherein the memory and the at least one processor are further configured to:
operate in a half-duplex mode in which a sidelink reception and the sidelink transmission associated with the sidelink communication are performed in non-overlapping slots.

15. A method of wireless communication at a wireless device that supports sidelink communication, comprising:
transmitting a sidelink transmission in a first set of one or more slots;
measuring a received signal strength indicator (RSSI) in a second set of slots, the RSSI indicative of a channel busy ratio (CBR) over a combined set of slots including both the first set of one or more slots and the second set of slots; and
transmitting the sidelink communication based on the CBR associated with the combined set of slots.

16. The method of claim 15, further comprising:
calculating the CBR in which the first set of one or more slots are excluded as slots for which an RSSI measurement exceeds a threshold and based on a reduced number of slots that excludes the first set of one or more slots.

17. The method of claim 16, wherein the CBR is based on a ratio between:
a first number of sub-channels having the RSSI measurement exceeding the threshold during the second set of slots, and
a number of slots in the second set of slots multiplied by a number of sub-channels in a frequency domain.

18. The method of claim 15, further comprising:
calculating the CBR in which the first set of one or more slots are excluded as slots for which an RSSI measurement exceeds a threshold.

19. The method of claim 18, wherein the CBR is based on a ratio between a first number of sub-channels having the RSSI measurement that exceeds the threshold during the second set of slots and a number of slots in the combined set of slots multiplied by a number of sub-channels in a frequency domain.

20. The method of claim 15, further comprising:
calculating the CBR in which the first set of one or more slots are included as slots for which an RSSI measurement exceeds a threshold.

21. The method of claim 20, wherein the CBR is based on a ratio between:
a first number of sub-channels having the RSSI measurement that exceeds the threshold during the second set of slots, and
a number of slots in the combined set of slots multiplied by a number of sub-channels in a frequency domain.

22. The method of claim 15, further comprising:
calculating the CBR in which the first set of one or more slots are considered to be busy and the second set of slots are considered to be idle.

23. The method of claim 15, wherein the CBR is based on a ratio between:
a number of one or more sub-channels in a frequency domain over the first set of one or more slots multiplied by a beta parameter associated with one or more idle sub-channels in the first set of one or more slots, and
a number of slots in the combined set of slots multiplied by the number of the one or more sub-channels in the frequency domain.

24. The method of claim 23, wherein the beta parameter corresponds to an additional ratio between the one or more idle sub-channels in the first set of one or more slots and the number of one or more sub-channels in the frequency domain over the first set of one or more slots.

25. The method of claim 15, further comprising adjusting a congestion control for the sidelink communication based on the CBR associated with the combined set of slots.

26. The method of claim 25, wherein adjusting the congestion control further comprises enabling the congestion control based on the CBR associated with the combined set of slots exceeding an RSSI threshold.

27. The method of claim 25, wherein adjusting the congestion control further comprises disabling the congestion control based on the CBR associated with the combined set of slots being below an RSSI threshold.

28. The method of claim 15, further comprising:
operating in a half-duplex mode in which a sidelink reception and the sidelink transmission associated with the sidelink communication are performed in non-overlapping slots.

29. An apparatus for wireless communication at a wireless device that supports sidelink communication, comprising:
means for transmitting a sidelink transmission in a first set of one or more slots;
means for measuring a received signal strength indicator (RSSI) in a second set of slots, the RSSI indicative of a channel busy ratio (CBR) over a combined set of slots including both the first set of one or more slots and the second set of slots; and
means for transmitting the sidelink communication based on the CBR associated with both the combined set of slots.

30. A non-transitory computer-readable storage medium storing computer executable code for wireless communication at a wireless device that supports sidelink communication, the code when executed by at least one processor causes the at least one processor to:
transmit a sidelink transmission in a first set of one or more slots;
measure a received signal strength indicator (RSSI) in a second set of slots, the RSSI indicative of a channel busy ratio (CBR) over a combined set of slots including both the first set of one or more slots and the second set of slots; and
transmit the sidelink communication based on the CBR associated with the combined set of slots.
